(19) United States
(12) Patent Application Publication
(10) Pub. No.: US 2009/0293618 A1
(43) Pub. Date: Dec. 3, 2009

(54) Acceleration Sensor Device

(75) Inventor: Yasuhiro Tamura, Tokyo (JP)

Correspondence Address: DOWELL & DOWELL P.C., 103 Oronoco St., Suite 220, Alexandria, VA, 22314, US

(73) Assignee: C & N Inc., Tokyo (JP)

(21) Appl. No.: 11/990,488

(22) PCT Filed: Aug. 18, 2005
(86) PCT No.: PCT/JP2005/015097

§ 371 Date: Aug. 10, 2009

(51) Int. Cl. G01P 15/12

(52) U.S. Cl. 73/514.33

(57) ABSTRACT

An acceleration sensor device includes an acceleration sensor chip fixed onto a substrate at its bottom, sealed with a molding resin. The acceleration sensor chip has an airtight sealed space for a weight portion to swing in, in accordance with acceleration applied, and a cushion member which covers a side surface and a top surface of the acceleration sensor chip is interposed between the molding resin and the acceleration sensor chip.

### TECHNICAL FIELD

The present invention relates to an acceleration sensor device having an acceleration sensor chip sealed with a molding resin.

### BACKGROUND TECHNOLOGY

Conventionally, acceleration sensors have been used in car-mounted air bag systems and the like. With the miniaturization and reduction in power consumption of acceleration sensors in recent years, small information terminals such as cellular phones have also started implementing acceleration sensors.

Various methods have been proposed for the principle of operation of the acceleration sensors, such as a piezoresistive acceleration sensor that utilizes a piezoresistive effect. The piezoresistive acceleration sensor has a weight portion and a beam portion for supporting the weight portion, which are formed by etching a silicon substrate. The beam portion is provided with a piezo resistor, the resistance of which varies when undergoing a stress. When an acceleration sensor element having such a structure is subjected to acceleration, the inertial force of the weight portion warps the beam portion causing a change in the resistance of the piezo resistor, so that an electric signal corresponding to the acceleration can be taken out.

When such an acceleration sensor element and an integrated circuit chip for processing electric signals output from the acceleration sensor element are integrated into an acceleration sensor device, it is necessary to secure space for the weight portion of the acceleration sensor element to swing in. Conventional acceleration sensor devices have thus used a metal or ceramic package for airtight sealing around the device (for example, Patent Document 1).

[Patent Document 1] Japanese Patent Application Laid-Open No. Hei 07-120492.

### DISCLOSURE OF THE INVENTION

### Problems to be Solved by the Invention

Airtight sealing using a metal or ceramic package, however, increases the parts count and necessitates the airtight sealing process, thereby increasing the cost of the acceleration sensor devices. One possible approach to reducing the cost of an acceleration sensor device is a package structure for sealing around the acceleration sensor element with a molding resin, in which case the structure must be such that the weight portion of the acceleration sensor element is not fixed by the molding resin.

When sealing the acceleration sensor element with a molding resin, consideration must also be given to the influence of contraction or expansion of the molding resin due to temperature variations in the external environment. More specifically, when the molding resin contracts or expands because of temperature variations and the acceleration sensor element accordingly undergoes stress, the beam portion of the acceleration sensor element warps, changing the resistance of the piezo sensor element. This makes it difficult to accurately detect acceleration, the detection target, and deteriorates the output characteristic of the acceleration sensor device.

The present invention has been achieved in view of the foregoing circumstances, and an objective thereof is to provide a low-cost acceleration sensor device by means of sealing with a molding resin without impairing its output characteristic.

### Means for Solving the Problems

To solve the foregoing problem, one embodiment of the present invention provides an acceleration sensor device including an acceleration sensor chip fixed onto a substrate at a bottom thereof, which is sealed with a molding resin. The acceleration sensor chip has an airtight sealed space for a weight portion to swing in, in accordance with acceleration applied. A cushion member which covers a side surface and a top surface of the acceleration sensor chip is interposed between the molding resin and the acceleration sensor chip.

According to this embodiment, the cushion member is interposed between the acceleration sensor chip and the molding resin, and stress occurring from contraction or expansion of the molding resin is thus relieved by the cushion member. This can consequently suppress distortion of the acceleration sensor chip, thereby avoiding deterioration in the output characteristic.

The acceleration sensor chip may include: an acceleration sensor element which has a frame body, a beam portion extended from an internal surface of the frame body toward the inside of the frame body, and a weight portion extending downward from part of a bottom of the beam portion; a top seal which covers an opening in a top surface of the frame body; and a bottom seal which covers an opening in a bottom surface of the frame body. A top surface of the beam portion may be spaced apart from the top surface of the frame body, and a bottom surface of the weight portion may be spaced apart from the bottom surface of the frame body.

In this case, since the top surface of the beam portion is spaced apart from the top surface of the frame body and the bottom surface of the weight portion is spaced apart from the bottom surface of the frame body, it is possible to secure space for the weight portion to swing in even if the openings of the frame body are covered by the top seal and the bottom seal having a flat shape. Since the space for the weight portion to swing in is made airtight by the top seal and the bottom seal, it is possible to prevent the cushion member and the molding resin from flowing into this space and hindering the swinging action of the weight portion. The top seal and the bottom seal also function as stoppers for confining the range of swing of the weight portion, and can thus prevent the beam portion from being broken when undergoing excessive acceleration.

A distance from the top surface of the frame body to the top surface of the beam portion and a distance from the bottom surface of the frame body to the bottom surface of the weight portion may be approximately the same. This allows the same degrees of swinging upward and downward when acceleration is applied.

It should be appreciated that arbitrary combinations of the foregoing constituting elements, and implementations of the invention in the form of methods, systems, and the like are also applicable as embodiments of the present invention.

### Effects of the Invention

According to the present invention, it is possible to provide an acceleration sensor device sealed with a molding resin without impairing the output characteristic.

### BRIEF DESCRIPTION OF THE DRAWINGS

FIG. 1 is a cross-sectional view of an acceleration sensor device according to an embodiment of the present invention;

FIG. 2 is a perspective view of an acceleration sensor chip;

FIG. 3 is a perspective view of an acceleration sensor element;

FIG. 4 is a diagram showing a multi-sensor apparatus which has a plurality of types of sensors packaged in one;

FIG. 5 is a flowchart showing the steps of manufacturing the multi-sensor apparatus.

### DESCRIPTION OF REFERENCE NUMERALS

10 acceleration sensor device, 12 substrate, 14 top seal, 16 acceleration sensor element, 18 bottom seal, 20 acceleration sensor chip, 22 molding resin, 24 cushion member, 26 beam portion, 28 weight portion, 30 frame body, 32 bonding pad, 34 wire, 38 solder ball, 40 signal processing chip, 42 piezoresistive element, 50 magnetic sensor chip, 60 pressure sensor chip, 62 pressure transmitting member, and 100 multi-sensor apparatus.

### THE BEST MODE FOR CARRYING OUT THE INVENTION

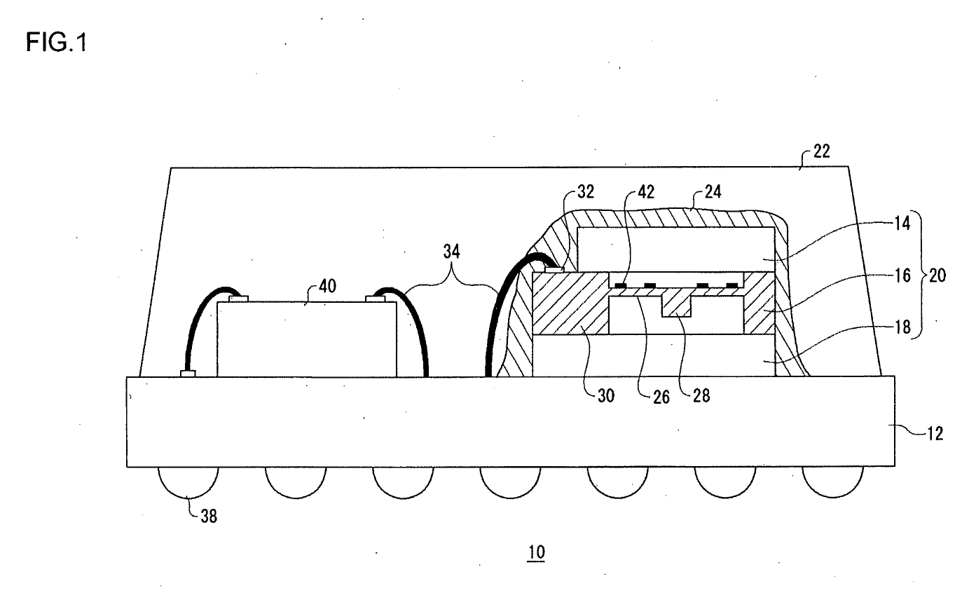

FIG. 1 is a cross-sectional view of an acceleration sensor device 10 according to an embodiment of the present invention. The acceleration sensor device 10 is an acceleration sensor device of BGA (Ball Grid Array) type. The acceleration sensor device 10 is mounted on a small information terminal such as a cellular phone, for example, and is used for such applications as detecting swinging of the small information terminal to detect the tilt of the same.

As shown in FIG. 1, the acceleration sensor device 10 has the structure in which an acceleration sensor chip 20 fixed onto a substrate 12 at its bottom and a signal processing chip 40 are sealed with a molding resin 22.

The substrate 12 is a substrate made of ceramic or organic glass, and is provided with not-shown circuit wiring on the top and in the interior of the substrate. The bottom of the substrate 12 is provided with a plurality of solder balls 38 which function as external terminals for inputting and outputting acceleration signals and a power supply voltage.

The acceleration sensor chip 20 and the signal processing chip 40 are fixed to the top of the substrate 12 with a die-bonding resin. The acceleration sensor chip 20 and the signal processing chip 40 are electrically connected with wires 34 and not-shown wiring formed on the substrate 12.

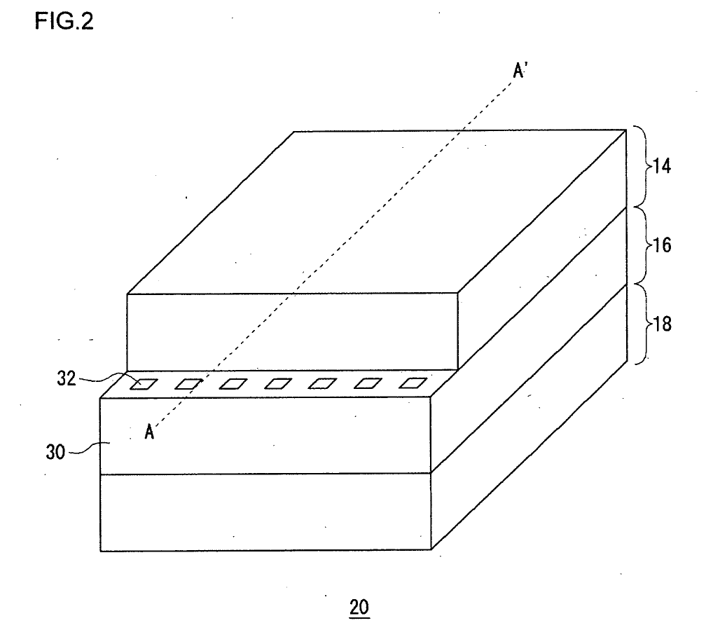

FIG. 2 is a perspective view of the acceleration sensor chip 20. The acceleration sensor chip 20 shown in FIG. 1 is the cross section taken along the line A-A′ of FIG. 2.

The acceleration sensor chip 20 includes an acceleration sensor element 16 which is the element for detecting acceleration, a top seal 14 which covers an opening in the top of a frame body 30 of the acceleration sensor element 16, and a bottom seal 18 which covers an opening in the bottom of the frame body 30.

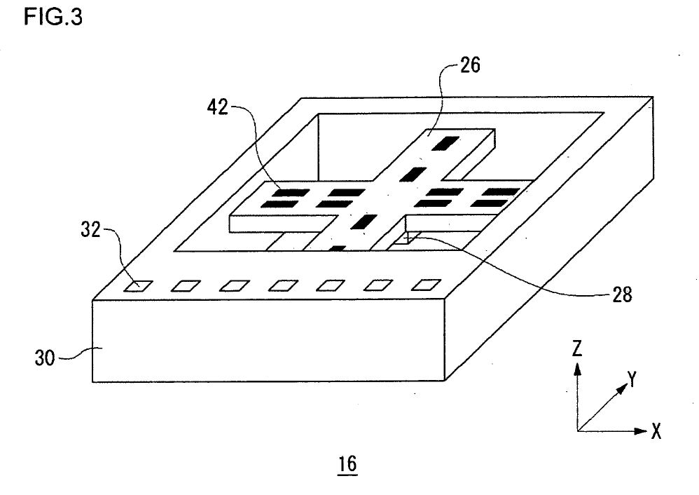

FIG. 3 is a perspective view of the acceleration sensor element 16. The acceleration sensor element 16 has a structure composed of the frame body 30, beam portions 26, and a weight portion 28 which are formed by dry etching a silicon base material. Piezoresistive elements 42 are formed on the beam portions 26.

The frame body 30 is the base member of the acceleration sensor chip 20, and is formed in a rectangular shape. The beam portions 26 are extended from the four internal surfaces of the frame body 30 toward the inside of the frame body 30, respectively, and intersect near the center of the opening of the frame body 30.

The beam portions 26 are formed with their top surfaces spaced apart from the top surface of the frame body 30. That is, the top surfaces of the beam portions 26 are not flush with the top surface of the frame body 30. The beam portions 26 are extended from intermediate positions between the top surface and bottom surface of the inner surfaces of the frame body 30. For example, the beam portions 26 are formed in such positions that the distances from the top surface of the frame body 30 to the top surfaces of the beam portions 26 are approximately 10 μm. The beam portions 26 are also formed in a small thickness so as to have elasticity, and are desirably formed to be approximately 5 μm.

The weight portion 28 is intended to swing in accordance with the magnitude of acceleration applied, thereby changing the amounts of warping of the beam portions 26. The weight portion 28 is formed to extend downward from the bottoms of the beam portions 26 at the area where the four beam portions 26 intersect. The weight portion 28 is a block member of rectangular prismatic shape. The weight portion 28 is formed with its bottom surface spaced apart from the bottom surface of the frame body 30. That is, the weight portion 28 is formed so that its bottom surface is not flush with the bottom surface of the frame body 30. The distance from the bottom surface of the frame body 30 to the bottom surface of the weight portion 28 is preferably made generally identical to the distances from the top surface of the frame body 30 to the top surfaces of the beam portions 26. For example, if the distances from the top surface of the frame body 30 to the top surfaces of the beam portions 26 are approximately 10 μm, the distance from the bottom surface of the frame body 30 to the bottom surface of the weight portion 28 is also set to approximately 10 μm.

The piezoresistive elements 42 are intended to convert the amounts of warping of the beam portions 26 deformed into electric signals. The piezoresistive elements 42 are formed on the surfaces of the beam portions 26. Four elements for each of X-, Y-, and Z-axes, or a total of twelve elements for the three axes, are arranged at the positions of the beam portions 26 where stresses concentrate on the most. The four elements on each axis constitute a Wheatstone bridge circuit to detect stress-based changes in resistance in the form of voltage variations. The acceleration signals detected are output from bonding pads 32.

The top seal 14 and the bottom seal 18 are made of silicon, or organic glass having a coefficient of thermal expansion similar to that of silicon. The top seal 14 and the bottom seal 18 are flat plates of rectangular shape. The bottom seal 18 has generally the same size as that of the frame body 30 of the acceleration sensor element 16. The top seal 14 is formed somewhat smaller than the frame body 30 so as to secure the forming area of the bonding pads 32.

The top seal 14 and the bottom seal 18 are joined to the acceleration sensor element 16 by anodic bonding at the peripheral areas of the opening of the frame body 30. The top seal 14 and the bottom seal 18 covers the opening of the frame body 30 so that the space for the weight portion 28 to swing in is sealed airtightly.

As mentioned above, the top surfaces of the beam portions 26 are spaced apart from the top surface of the frame body 30, and the bottom surface of the weight portion 28 is spaced apart from the bottom surface of the frame body 30. if the top surfaces of the beam portions 26 are not spaced apart from the top surface of the frame body 30 and the bottom surface of the weight portion 28 is not spaced apart from the bottom surface of the frame body 30, the top seal 14 and the bottom seal 18 must be recessed in order to secure the space for the weight portion 28 to swing in. According to the present embodiment, the top seal 14 and the bottom seal 18 may be flat plates, not requiring the recess forming process. This allows a reduction in manufacturing cost.

In addition, the top seal 14 and the bottom seal 18 function as stoppers for confining the range of swing of the weight portion 28, and thus prevent the beam portions 26 from being broken when undergoing excessive acceleration. If the distance from the bottom surface of the frame body 30 to the bottom surface of the weight portion 28 is made generally equal to the distances from the top surface of the frame body 30 to the top surfaces of the beam portions 26, the same degree of swinging is allowed upward and downward.

The signal processing chip 40 shown in FIG. 1 integrates processing circuits such as a circuit for performing arithmetic processing on the acceleration signals in the respective axial directions, obtained from the Wheatstone bridges of the piezoresistive elements 42. Although omitted from the drawings, it may also include an EEPROM or other memory cell chips for storing data necessary for arithmetic processing such as data regarding the correspondence between the levels of the detection signals and the magnitudes of acceleration.

The acceleration sensor chip 20 and the signal processing chip 40 are sealed with the molding resin 22. In this instance, as shown in FIG. 1, a cushion member 24 for covering the side surfaces and the top surface of the acceleration sensor chip 20 is interposed between the acceleration sensor chip 20 and the molding resin 22.

In general, when sealing with a molding resin, the target article is covered by a heated liquid molding resin and then cooled for molding. In this case, the molding resin contracts during cooling. When the acceleration sensor chip 20 directly covered with the molding resin is cooled, stress occurring from the contraction distorts the acceleration sensor chip 20 and warps the beam portions 26, changing the resistances of the piezoresistive elements 42. Consequently, when the acceleration sensor chip 20 is directly sealed with the molding resin, the acceleration signals may change in offset value, with deterioration in the output characteristic. Even after the sealing process, the molding resin causes contraction or expansion due to temperature variations in the external environment. This again changes the resistances of the piezoresistive elements 42, with deterioration in the output characteristic.

According to the present embodiment, the cushion member 24 is interposed between the acceleration sensor chip 20 and the molding resin 22. The cushion member 24 then relieves the stress on the acceleration sensor chip 20 caused by contraction or expansion of the molding resin, and suppresses distortion of the acceleration sensor chip 20. This can consequently suppress warpage of the beam portions 26, and suppress resistance variations in the piezoresistive elements 42. It is therefore possible to avoid deterioration in the output characteristic of the acceleration sensor device 10. The cushion member 24 may be made of silicon resin, for example. It should be appreciated that the signal processing chip 40 has no portion that varies mechanically, and therefore need not be covered with the cushion member 24 but may be sealed with the molding resin 22 directly.

Moreover, in the present embodiment, the space for the weight portion 28 to swing in is made airtight. This can prevent the cushion member 24 from flowing into the space for the weight portion 28 to swing in and hindering the swinging action of the weight portion 28.

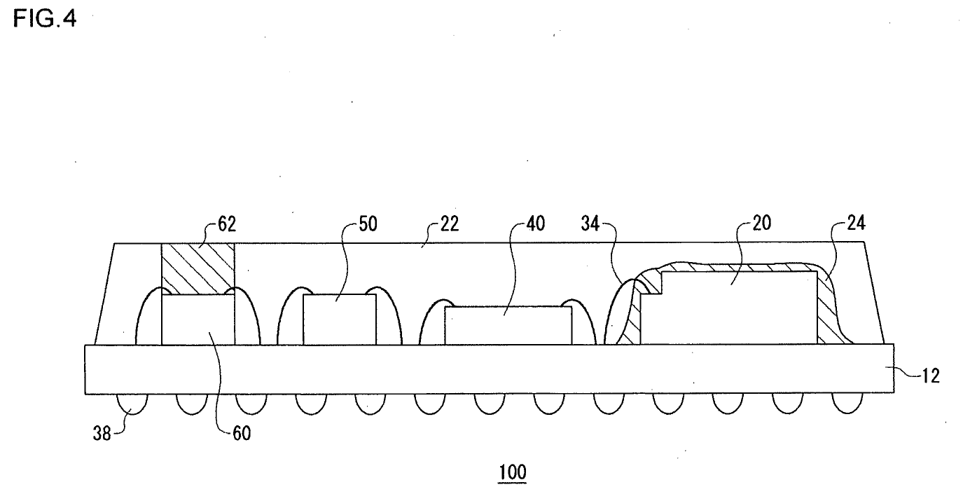

FIG. 4 is a diagram showing a multi-sensor apparatus 100 which has a plurality of types of sensors packaged in one. The multi-sensor apparatus 100 includes the acceleration sensor chip 20, a magnetic sensor chip 50 for detecting magnetism, a pressure sensor chip 60 for detecting pressure, and a signal processing chip 40 for processing signals output from these sensors.

As shown in FIG. 4, the acceleration sensor chip 20 is covered with the cushion member 24 at the side surfaces and the top surface. The magnetic sensor chip 50 and the signal processing chip 40 are directly sealed with the molding resin 22 since they have no portion that varies mechanically. A pressure transmitting member 62 of gel form is arranged on the top of the pressure sensor chip 60.

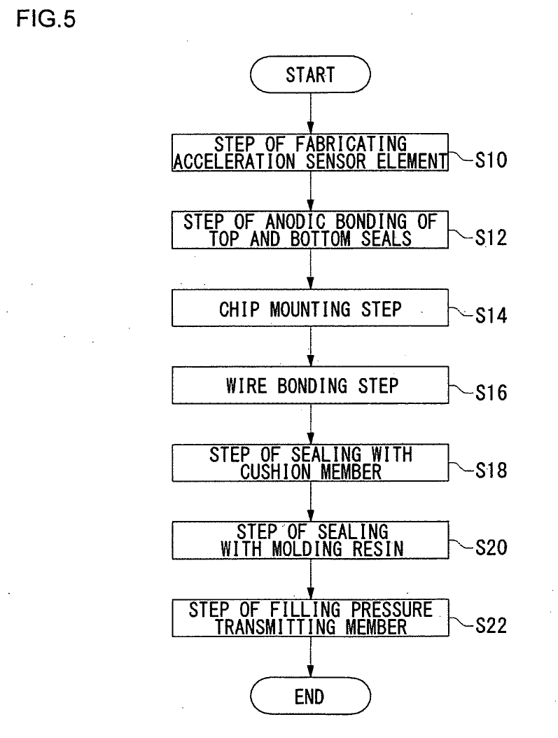

FIG. 5 is a flowchart showing the steps of manufacturing the multi-sensor apparatus 100. Initially, a silicon substrate is etched to fabricate the acceleration sensor element 16 (S10) . Next, the top seal 14 and the bottom seal 18 are joined to the acceleration sensor device 16 by an anodic bonding at the peripheral areas of the opening of the frame body 30 (S12).

Next, the acceleration sensor chip 20, the signal processing chip 40, the magnetic sensor chip 50, and the pressure sensor chip 60 are mounted on the top of the substrate 12, which has solder balls 38 formed on its underside (S14). The acceleration sensor chip 20 is desirably mounted using a silicon die-bonding resin. As mentioned above, the bottom seal 18 is made of silicon or organic glass having a coefficient of thermal expansion similar to that of silicon. The acceleration sensor chip 20 might thus be distorted if, for example, an epoxy die-bonding resin having a coefficient of thermal expanding much different from that of silicon were used. The use of the silicon die-bonding resin can minimize the distortion.

After the acceleration sensor chip 20, the signal processing chip 40, the magnetic sensor chip 50, and the pressure sensor chip 60 are mounted, a wire bonding step is performed (S16). Subsequently, the side surfaces and the top surface of the acceleration sensor chip 20 are covered with the cushion member 24 for sealing (S18). When using silicon resin for the cushion member, the top surface and the side surfaces of the acceleration sensor chip 20 are covered with the silicon resin in liquid form, and then heated for curing.

After the sealing with the cushion member 24, a step of sealing with a molding resin is performed (S20). The chip-mounted substrate 12 is set in a die molding machine, into which a heated liquid molding resin is fed by pressure for molding. In this instance, the die is shaped so that the molding resin does not flow over the top of the pressure sensor chip 60. Subsequently, the hole formed over the top of the pressure sensor chip 60, surrounded by the molding resin 22, is filled with the pressure transmitting member 62 in gel form (S22).

Up to this point, the present invention has been described in conjunction with the embodiment thereof. This embodiment has been given solely by way of illustration. It will be understood by those skilled in the art that various modifications may be made to combinations of the foregoing constituting elements and processes, and all such modifications are also intended to fall within the scope of the present invention.

### INDUSTRIAL APPLICABILITY

The present invention is applicable to fields pertaining to acceleration sensor devices.

What is claimed is:

1. An acceleration sensor device comprising:
an acceleration sensor chip fixed onto a substrate at a bottom thereof, which is sealed with a molding resin, wherein
the acceleration sensor chip comprises:
an acceleration sensor element which comprises a frame body, a beam portion extended from an internal surface of the frame body toward the inside of the frame body, and a weight portion extending downward from part of a bottom of the beam portion;
a top seal which covers an opening in a top surface of the frame body; and
a bottom seal which covers an opening in a bottom surface of the frame body, wherein
the openings of the frame body are covered with the top seal and the bottom seal so as to make an airtight sealed space for the weight portion to swing in, in accordance with acceleration applied, wherein
a top surface of the beam portion is spaced apart from the top surface of the frame body, and a bottom surface of the weight portion is spaced apart from the bottom surface of the frame body, wherein
a distance from the top surface of the frame body to the top surface of the beam portion and a distance from the bottom surface of the frame body to the bottom surface of the weight portion are approximately the same, and wherein
a cushion member which covers a side surface and a top surface of the acceleration sensor chip is interposed between the molding resin and the acceleration sensor chip.

2. An acceleration sensor device according to claim 1,
wherein the beam portion is provided with a piezoresistive element which detects an amount of warping of the beam portion when the beam portion is deformed.

3. An acceleration sensor device according to claim 2,
wherein the beam portion is provided with four piezoresistive elements for each of X-, Y-, and Z-axes, and the four piezoresistive elements on each axis constitute a Wheatstone bridge circuit.
